(19) United States
(12) Patent Application Publication
(10) Pub. No.: US 2010/0241534 A1
(43) Pub. Date: Sep. 23, 2010

(54) SYSTEM AND METHOD FOR REPORTING QUALIFYING PURCHASES

(76) Inventor: Steven Tingley-Hock, Westerville, OH (US)

Correspondence Address: Lech Law, LLC, P.O. Box 3473, Dublin, OH, 43016, US

(21) Appl. No.: 12/693,404

(22) Filed: Jan. 25, 2010

Related U.S. Application Data
(60) Provisional application No. 61/146,909, filed on Jan. 23, 2009.

(51) Int. Cl. G06Q 10/00; G06Q 30/00; G06F 17/00

(52) U.S. Cl. 705/30; 726/11

(57) ABSTRACT

A method for reporting qualifying purchases is disclosed. The method comprises processing a purchase. The processing comprises storing a card number, a transaction identifier and at least one item identifier. The method further comprises matching the card number with a list of card numbers associated with participating card holders; assigning a customer number corresponding to the card number to conceal the card number; associating the transaction identifier and the at least one item identifier with the customer number; determining, for each of the at least one item identifier, whether the item identifier corresponds to a qualifying purchase; and transmitting each item identifier corresponding to a qualifying purchase to a third party.

### CROSS REFERENCE TO RELATED APPLICATION

This application claims priority from U.S. Provisional Application No. 61/146,909 filed Jan. 23, 2009, which is incorporated by reference as if fully set forth herein.

### TECHNICAL FIELD

The present application generally relates to methods and systems for processing payments. More specifically, the present application relates to methods and systems for processing and transmitting transaction detail to a third party administrator.

### BACKGROUND

For some time, systems and methods for electronically processing payments for goods and services have been widely used. Every day, millions of financial transactions occur throughout the world, and electronic records of the transactions are created for most of these transactions. For example, one common type of financial transaction involves the use of a presentation instrument, such as a credit card, a debit card, or the like. When such a presentation instrument is used to make a purchase, information stored on the card may be read by a point of sale device. This information is used to create an electronic record of the purchase. In the case of credit/debit cards, the information read by the point of sale device along with the amount of the purchase may be routed through various entities in order to complete the purchase. For example, the transaction information may be electronically sent to a financial intermediary also known as a transaction facilitator. Such an institution may be an independent processor, a vendor's bank or financial institution, and/or a credit card association, such as VISA or MasterCard, or card issuer such as American Express or Discover. Each of these entities may also store information regarding the transaction.

Typically, a financial intermediary stores a summary of each transaction, including a customer/purchaser identifier, vendor identifier, a date of transaction and the amount of the transaction. The financial intermediary may further assign and store an internal transaction identifier, such as a sequential number that may be used to uniquely identify a summary transaction record. Generally, a merchant or vendor will maintain more detailed data regarding a transaction, including the product names, product identifiers, product descriptions, product prices, tax amounts and rates, where applicable, and a total amount of the transaction. The vendor also may assign an internal transaction identifier, such as a receipt number, that is not typically transmitted with the summary transaction data.

### BRIEF DESCRIPTION OF THE DRAWINGS

The accompanying figures, which are incorporated in and constitute a part of the specification, illustrate various example apparatuses, systems, methods, and so on, and are used merely to illustrate various example embodiments. It should be noted that various components depicted in the figures may not be drawn to scale, and that the various assemblies and designs depicted in the figures are presented for purposes of illustration only, and should not be considered in any way as limiting.

FIG. 1 is a schematic block diagram illustrating an example transaction processing and reporting environment.

FIG. 2 is a flowchart illustrating an example methodology for processing and reporting qualifying purchased.

### DETAILED DESCRIPTION OF THE DRAWINGS

Under certain circumstances, it would be desirable to obtain detailed transaction data for a number of transactions associated with a particular customer, or cardholder. For example, many businesses supply certain employees with credit cards to be used exclusively for business expenses. For such a business, it would be advantageous to obtain the transaction detail of a corporate expense account for auditing purposes to ensure compliance with company policies and tax laws. Presently, in order to document business expenses incurred using a corporate account, employees are directed to submit either a credit card statement that lacks the desired transaction detail or individual receipts that are difficult to process and are easily lost or destroyed. For each receipt lost or destroyed, the detailed transaction data or a replacement receipt must be obtained directly from the vendor who performed the transaction.

To avoid the difficulty of manually identifying and contacting multiple vendors to obtain the necessary documentation, it would be advantageous to automatically obtain transaction detail data from a single source. One solution to this problem would be to provide a payment-processing environment in which every vendor provides transaction detail data to the financial intermediary for every transaction. In such an environment, the financial intermediary would store transaction detail for every transaction. Such a solution, however, introduces a burden on both the payment-processing network generally and each financial intermediary specifically. The payment-processing network would be burdened by an increase in bandwidth required for each transaction. Each financial intermediary would be burdened by increased storage capacity required to maintain the transaction detail data.

Consequently, there is a need for methods and systems that address the aforementioned shortcomings of current payment processing and reporting applications without significantly increasing the burden on existing systems.

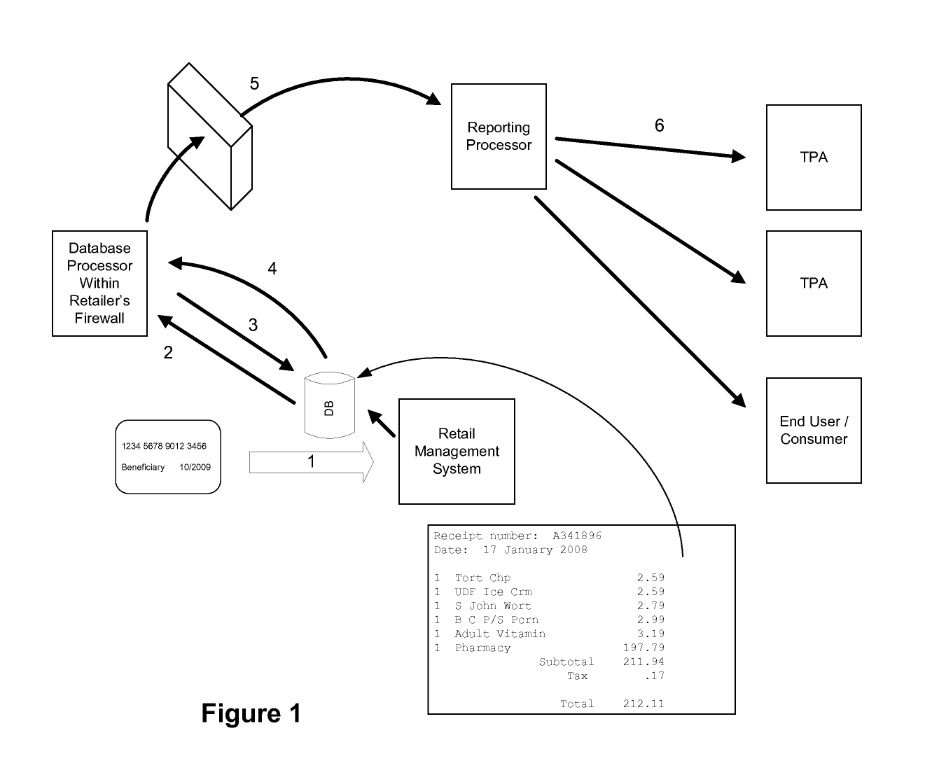

FIG. 1 illustrates an example data processing system, and certain methods for using the system, which addresses the aforementioned shortcomings of current payment processing and reporting applications. In one example situation, a person may use a credit, debit, stored value, gift or insurance card to make a purchase at a retailer. The retailer's point-of-sale system (“POS”) or other data store is retains all of the following three (3) types of data:

1) The identifier (number) of the card used. This can be a credit, debit, insurance, stored value or gift. In the discussion below, it will be referred to as the “CN”;

2) The identifier of the transaction. Commonly called a receipt number. In the discussion below, it will be referred to as the “TI”; and

3) All of the detail associated with the transaction. This includes, but is not limited to, the name of each of the items purchased, the identifier (this could be a SKU, etc.) associated with each of the items purchased, the cost of each item purchased, the sub-total of the items purchased, the percentage of taxation applied to the purchase and/or the amount of tax applied to the purchase and the total amount of the transaction.

As illustrated with reference to FIG. 1, after the successful completion of a transaction where a card is used to pay for part or all of the purchase, illustrated by reference numeral 1, the following data are stored in the retailer's POS or retail tracking system: the TI, CN, and, if it is not included as part of the TI, the location of where the data is stored. This is list “A”.

As indicated at reference numeral 2, list “A” is moved/transferred from the retailer's POS or retail management/tracking system to a database management system (“DBMS”) housed on another system. This new system will be referred to as the Matching System (“MS”). Also housed on the DBMS running on the MS is list “B”. List “B” contains CN's and an Alternate Person Identifier (“API”) of individuals who, for various reasons, want the detail of their retail transactions.

As indicated at reference numeral 3, list “A” and list “B” are compared based on the CN's of each list. This new list is list “C”. List “C”, housed on the MS, contains the TI, CN, and API. In certain situations, list “C” may also contain the location of the selected, matching transactions.

The CN is then omitted or deleted from List “C”. List “C” now contains the TI, API and, in certain situations, the location of the data. This step, while not necessary, allows a retailer to maintain control of the identifier (card number) of the card used to complete the purchase. This may be done if the retailer does not want to pass along personal identification information.

The TI's contained in list “C” are submitted from the MS to the retailer's transaction detail data store (the POS system or other data store) to acquire the transaction detail associated with each TI. The resulting list is list “D” and is indicated by reference numeral 4. List “D” has the submitted TI's and the detail associated with each of those TI's.

List “D” is transferred to the MS.

On the MS, the aggregated data on list “C” are merged with the aggregated data on list “D” by TI, creating list “E”. List “E” may be transferred to a third party for processing/distribution at reference numeral 5. List “E” comprises of a TI, the API associated with that TI and the detail associated with each TI.

The TI may then be omitted or removed from list “E”. List “E” now comprises of API's and the transaction detail associated with each API.

At this point, as indicated at reference numeral 6, the data contained by list “E” can be used to/for:
Creating electronic receipts for customers.
Matching against a list of eligible products and used to substantiate claims for reimbursement to an administrator of CDH accounts.
Creating of enhanced credit card statements where the detail of credit card transactions is provided.
Creating of enhanced checking account statements where the detail of debit card transactions is provided.
Submitting to an electronic health record provider.
Submitting to an aggregator so that the detail of the financial transaction can be downloaded into a personal money management program.
Loading into a company's expense management system to substantiate expenses.
Managing and/or auditing food stamp payment systems.

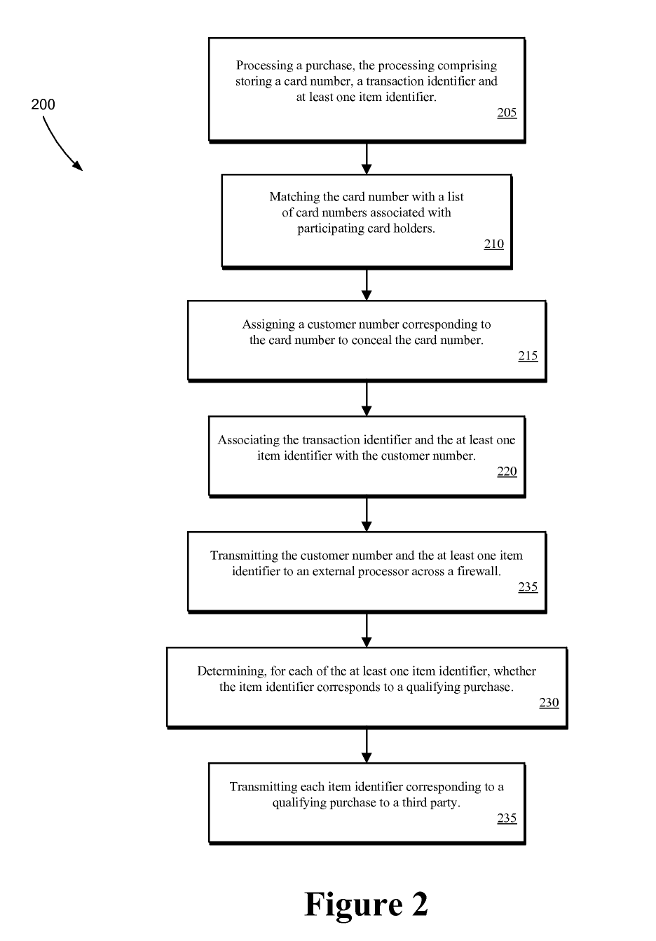

Referring now to FIG. 2, there is a flowchart illustrating an example methodology 200 for reporting qualifying purchases, such as reimbursable health care purchases or business expenses. By way of example, the methodology will be described from the perspective of the system of FIG. 1, although the methodology may be employed easily by other entities. At block 205, a retail management system processes a purchase. The purchase may be accomplished using a debit card, credit card or other form of payment having a payment identifier, such as a card number. The processing comprises storing the card number, a transaction identifier associated with the transaction and at least one item identifier. Each item identifier represents at least one item purchased.

At block 210, the system matches the card number used for the purchase with a list of card numbers associated with participating card holders. Block 205 may be performed by a database processor within the retailer's firewall to maintain security. At block 215, the database processor or other system component assigns a customer number corresponding to the card number. The customer number is used to conceal the card number and protect the account from unauthorized use.

As shown at blocks 220 and 225, the system associates the transaction identifier and the at least one item identifier with the customer number and optionally transmits the customer number and the at least one item identifier to an external processor over the firewall. The external processor or other system component determines, for each of the at least one item identifier, whether the item identifier corresponds to a qualifying purchase at block 230. At block 235, the system transmits each item identifier corresponding to a qualifying purchase to a third party. The third party may be a computer system of a third party administrator or a computer system of the purchasing customer, among other entities.

Unless specifically stated to the contrary, the numerical parameters set forth in the specification are approximations that may vary depending on the desired properties sought to be obtained according to the exemplary embodiments. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and so on have been illustrated by describing examples, and while the examples have been described in considerable detail, it is not the intention of the applicant to restrict, or in any way, limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

Finally, to the extent that the term “includes” or “including” is employed in the detailed description or the claims, it is intended to be inclusive in a manner similar to the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modern Legal Usage 624 (2d. Ed. 1995).

What is claimed is:

1. A method for reporting qualifying purchases, comprising:
processing a purchase, the processing comprising storing a card number, a transaction identifier and at least one item identifier;
matching the card number with a list of card numbers associated with participating card holders;
assigning a customer number corresponding to the card number to conceal the card number;
associating the transaction identifier and the at least one item identifier with the customer number;
determining, for each of the at least one item identifier, whether the item identifier corresponds to a qualifying purchase; and
transmitting each item identifier corresponding to a qualifying purchase to a third party.

2. The method of claim 1 further including transmitting the customer number and the at least one item identifier to an external processor.

3. The method of claim 1 further including transmitting the customer number and the at least one item identifier to an external processor across a firewall;

4. The method of claim 1 wherein the third party comprises a computer system of a third party administrator.

5. The method of claim 1 wherein the third party comprises a computer system of a card holder associated with the customer number.
